(19) United States
(12) Patent Application Publication
(10) Pub. No.: US 2024/0402503 A1
(43) Pub. Date: Dec. 5, 2024

(54) Automatic Display Adjustment

(71) Applicant: Apple Inc., Cupertino, CA (US)

(72) Inventors: James A. McCombe, San Francisco, CA (US); Ahmad Diab-Marzouk, Westminster, CO (US); Arun Srivatsan Rangaprasad, Sunnyvale, CA (US); Joel N. Kerr, San Jose, CA (US); Tyler R. Calderone, Boulder, CO (US); William E. Blumhardt, San Francisco, CA (US); Zhengzheng Li, Cupertino, CA (US)

(21) Appl. No.: 18/616,869

(22) Filed: Mar. 26, 2024

Related U.S. Application Data
(60) Provisional application No. 63/586,700, filed on Sep. 29, 2023.
(60) Provisional application No. 63/505,933, filed on Jun. 2, 2023.

(51) Int. Cl. G02B 27/01; G02B 27/00

(52) U.S. Cl. CPC G02B 27/0176; G02B 27/0093; G02B 27/0179; G02B 2027/014; G02B 2027/0163; G02B 27/0172

(57) ABSTRACT

Facilitating the fit of a head mounted device includes calculating a nominal interocular distance (IOD) using a nominal eye model. A device IOD is based on a distance between a first optical module and a second optical module of the headset. The device IOD is compared to the calculated nominal IOD. If a difference between the device IOD and the calculated nominal IOD satisfies a threshold, an adjustment process is initiated to modify the distance between the first optical module and the second optical module.

### BACKGROUND

Some devices can generate and present Extended Reality (XR) Environments. An XR environment may include a wholly or partially simulated environment that people sense and/or interact with via an electronic system. In XR, a subset of a person's physical motions, or representations thereof, are tracked, and in response, one or more characteristics of one or more virtual objects simulated in the XR environment are adjusted in a manner that comports with realistic properties. In some instances, the electronic system may be a headset or other head mounted device. As such, improvements are needed to improve headset fit.

### BRIEF DESCRIPTION OF THE DRAWINGS

FIG. 1 shows an example diagram of a headset fit, in accordance with one or more embodiments.

FIG. 2 shows a diagram of a headset having been fit for a user IOD, in accordance with one or more embodiments.

FIG. 3 shows a flowchart of a technique for modifying a device IOD for a user fit, in accordance with some embodiments.

FIG. 4 shows a flowchart for adjusting a headset fit in accordance with a user-specific eye model, in accordance with one or more embodiments.

FIG. 5 shows a flowchart of a technique for performing a target movement of optical modules on a headset, in accordance with some embodiments.

FIG. 6 shows a flowchart of a technique for accessibility modes for modifying a device IOD for a user fit, in accordance with some embodiments.

FIG. 7 shows a system diagram of an electronic device, in accordance with one or more embodiments.

FIG. 8 shows an exemplary system for use in various extended reality technologies.

### DETAILED DESCRIPTION

This disclosure pertains to systems, methods, and computer readable media to facilitate improved headset fit. In particular, this disclosure relates to a technique for determining a corrective action and initiating adjustment for an improved headset fit.

A headset may include optical modules configured to be placed in front of each of the user's eyes. These optical modules may be adjustable such that they may be positioned with a particular distance corresponding to an interocular distance (IOD) of a user. However, when a user places the headset on their head, a user specific IOD may not match the IOD at which the device is set. For purposes of this disclosure, the IOD refers to a distance between two eyes or optical modules based on one or more reference points of the eyes or optical modules, such as a central point, pupil location, or the like. This may lead to reduced visual quality or user experience of the headset.

In some embodiments, the distance between the optical modules on a device can be modified to better match a user specific IOD. In particular, a nominal eye model may be used to determine, based on eye tracking data, the initial user IOD, referred to herein as a nominal IOD because it is determined using a nominal eye model. The nominal eye model may be based on characteristics of a generic eye. The location of each of the user's eyes can be determined based on the nominal eye model. In some embodiments, the location may be based on a central point in the eye, a pupil location, or the like. The nominal IOD may be compared against the device IOD to determine whether the device IOD should be adjusted. In some embodiments, an optical tolerance may be considered to determine whether the nominal IOD is within a threshold of the device IOD. If the difference between the nominal IOD and the device IOD satisfies a threshold, then an adjustment process will be initiated to modify the device IOD.

Modifying the device IOD may include determining a target movement of the optical modules of the device. The target movement may indicate, for example, a distance and direction each of the optical modules should move in order to correspond to the nominal eye model. In some embodiments, the optical modules may move independently, or maybe together. Further, the optical modules may move in a symmetric matter, such as an equal distance and opposite directions, or may move independently such that each module may move a different distance and/or direction.

According to some embodiments, the optical modules may move automatically in response to determining the target movement, or may move in response to user input. For example, in some embodiments, having user input trigger the movement of the optical modules may provide an improved user experience. As such, a user may provide an input, such as the press of a button, a turn of a crown, or the like, which causes the optical modules to be moved in accordance with the target movement. The nominal IOD measurement may be stored for future use, and passthrough functionality may be enabled on the device.

In the following disclosure, a physical environment refers to a physical world that people can sense and/or interact with without aid of electronic devices. The physical environment may include physical features such as a physical surface or a physical object. For example, the term physical environment may correspond to a physical park that includes physical trees, physical buildings, and physical people. People can directly sense and/or interact with the physical environment, such as through sight, touch, hearing, taste, and smell. In contrast, an XR environment refers to a wholly or partially simulated environment that people sense and/or interact with via an electronic device. For example, the XR environment may include Augmented Reality (AR) content, Mixed Reality (MR) content, Virtual Reality (VR) content, and/or the like. With an XR system, a subset of a person's physical motions, or representations are tracked, and in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and adjust graphical content and an acoustic field presented to the person in a manner, similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include: head-mountable systems, projection-based systems, heads-up displays (HUD), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram, or on a physical surface.

In the following description for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, resort to the claims being necessary to determine such inventive subject matter. Reference in this disclosure to “one embodiment” or to “an embodiment” means that a particular feature, structure or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developers' specific goals (e.g., compliance with system-and business-related constraints) and that these goals may vary from one implementation to another. It will also be appreciated that such development efforts might be complex and time-consuming but would, nevertheless, be a routine undertaking for those of ordinary skill in the design and implementation of graphics modeling systems having the benefit of this disclosure.

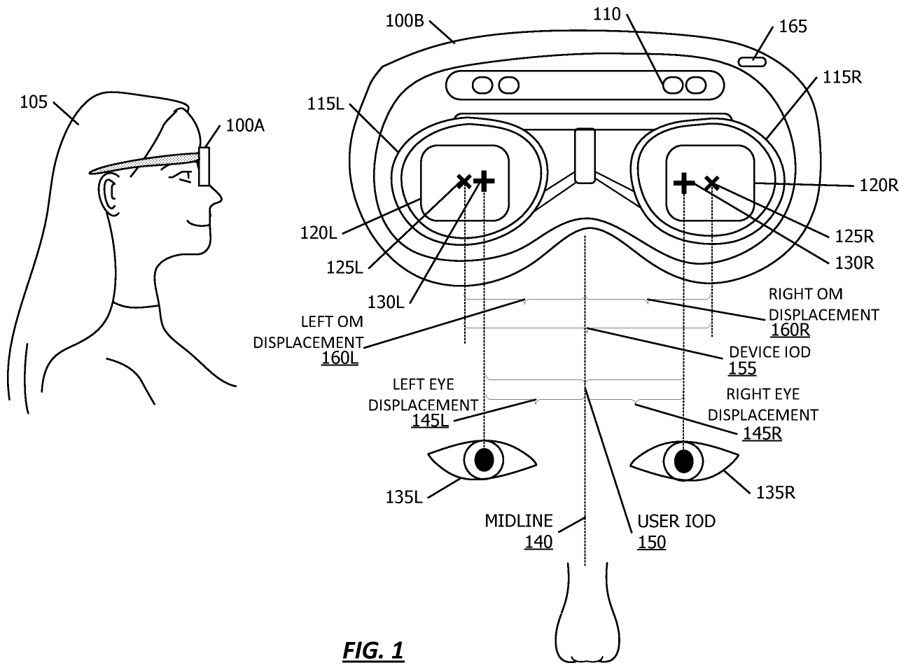

FIG. 1 shows an example diagram of a headset fit, in accordance with one or more embodiments. In this example, user 105 is wearing a headset 100A. A front view of headset is presented as headset 100B, along with the relative position of the headset 100 to the user's left eye 135L, right eye 135R, and midline 140. For purposes of this example, the midline 140 may be determined by a nasal axis of the user, or the like. In addition, for purposes of this example, headset 100A, and the front view of headset 100B are referred to generically as headset 100.

The headset 100 may include numerous components which affect the fit of the headset 100 on the user 105. The headset 100 may include a left optical module 115L and a right optical module 115R. The left optical module 115L may include a left display 120L, and an intended target 125L for a left eye 135L on the display 120L. Similarly, the headset 100 may include a right optical module 115R. The right optical module 115R may include a right display 120R, and an intended target 125R for a right eye 135R on the display 120R. The resulting distance between the left optical module 115L and the right optical module 115R is considered to be the device IOD 155. The device IOD 155 is comprised of a left optical module displacement 160L, which is a distance between the determined location of the left optical module 115L and midline 140. The midline 140 may be a central axis of the headset 100, which may align with the nasal axis. Similarly, the device IOD 155 is comprised of a right optical module displacement 160R, which is a distance between the determined location of the right optical module 115R and midline 140.

Separate from the device, the user 105 may have a user specific IOD. The user specific IOD may be based on a distance between a location of the left eye 135L and the right eye 135R. For example, a distance between the optical center of the left eye 135L and the optical center of the right eye 135R may be determined. This distance may be considered the user IOD 150. The location of the left eye 135L and the location of the right eye 135R may be determined using eye tracking data. For example, one or more sensors 110 on the device 100 may capture sensor data of the users' eyes. The sensor data may be applied to an eye model which is configured to use sensor data to predict characteristics of an eye. These characteristics may include, for example, a representative eye location, such as a central portion of the eye, pupil location, or the like. In some embodiments, a central location of the eye may be determined based on a gaze vector originating at the eye. An opposite vector can be determined going into the eye some distance, according to an eye model, to determine an eye center, such as a center of an eyeball. The location may be determined, for example, in a device coordinate system. The relative locations of the left eye 135L and the right eye 135R can be used to determine the user IOD 150. In some embodiments, the user IOD 150 is comprised of a left eye displacement 145L, which is determined based on a distance from the left eye 135L and the midline 140. The user IOD 150 is also comprised of a right eye displacement 145R, which is determined based on the distance from the right eye 135R and the midline 140.

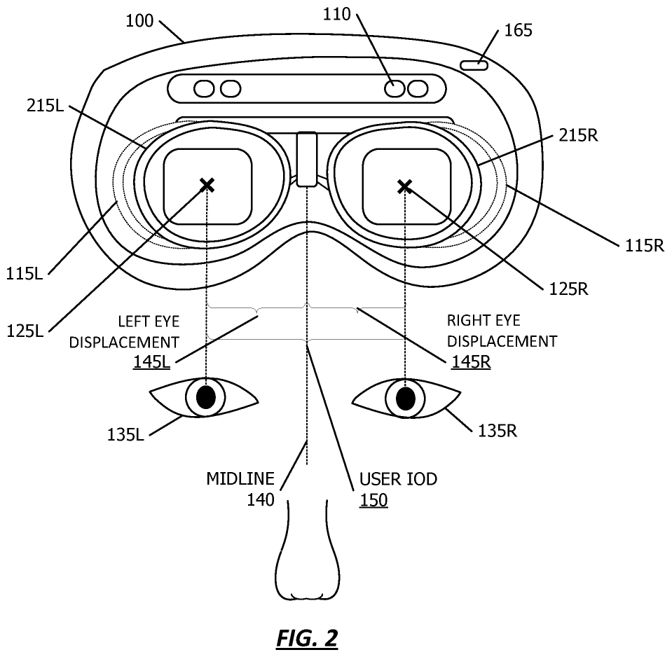

According to some embodiments, the user IOD 150 may be different than the device IOD 155. As shown here, the user IOD 150 is narrower than the device IOD 155. As a result, the left eye target 130L on the display 120L is offset from the intended target 125L. Similarly, the right eye target 130R on the display 120R is offset from the intended target 125R. According to some embodiments, the optical modules 115L and 115R may be coupled to one or more motors which causes the physical placement of the optical modules 115L and 115R to change. For example, as will be described below with respect to FIG. 2, the optical modules 115L and 115R may move in a horizontal direction to approach a user IOD 150. Said another way, the optical module 115L and the optical module 115R may be adjusted such that the left intended target 125L and the right intended target 125R approach the left eye target 130L and the right eye target 130R. In some embodiments, the optical modules may be adjusted in response to user input, such as through crown 165 on the headset 100.

According to some embodiments, the left eye displacement 145L in the right eye displacement 145R may be the same or may be different. For example, some users may exhibit a nasal pupillary asymmetry, resulting in a different distance between a left eye and a nasal axis, and the right eye and the nasal axis. In some embodiments, the left optical module displacement 160L can be compared against the left eye displacement 145L, while the right optical module displacement 160R is compared against the right eye displacement 145R to determine separate target movements for the left optical module 115L and the right optical module 115R. As such, the target movements of the left optical module 115L and the right optical module 115R may be determined independent of each other, according to some embodiments.

FIG. 2 depicts an example diagram of headset 100 after the optical modules have been adjusted. In particular, the dotted line showing left optical module 115L and right optical module 115R show the placement of the optical modules as shown in FIG. 1. By contrast, left optical module 215L is presented at a new location. Similarly, right optical module 215R is presented at a new location. In this diagram, the left intended target 125L aligns with the left eye target, and the right intended target 125R aligns with the right eye target. As such, the device IOD is now the same or similar to the user IOD 150.

Although in FIG. 2, the device IOD and user IOD are now aligned, in some embodiments, the adjustment process may move the optical modules such that the eye and the optical modules are within a threshold distance. For example, an optical tolerance may be determined or provided which indicates a difference between a device IOD and a user IOD at which the difference is imperceptible, or otherwise allowable. The optical tolerance can be used to determine a range of placements of the optical modules within which the display adjustment will be acceptable.

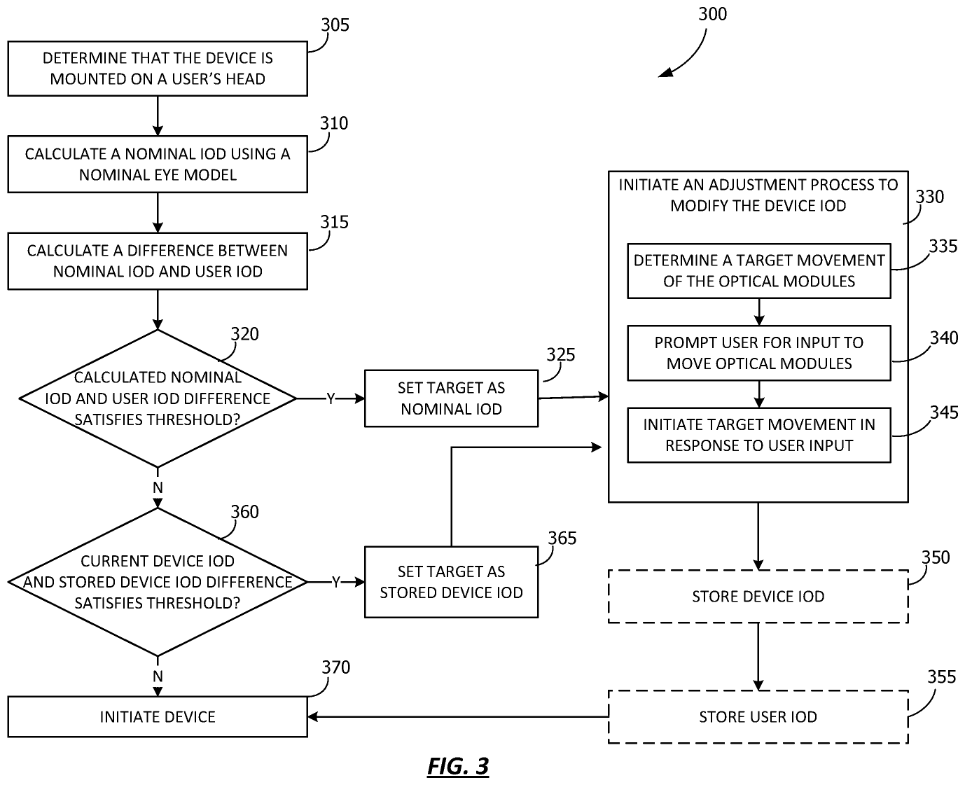

FIG. 3 shows a flowchart of a technique for modifying a device IOD for a user fit, in accordance with some embodiments. In particular, the flowchart presented in FIG. 3 depicts an example technique for adjusting a headset display based on a nominal eye model. For purposes of explanation, the following steps will be described as being performed by particular components of FIGS. 1-2. However, it should be understood that the various actions may be performed by alternate components. In addition, the various actions may be performed in a different order. Further, some actions may be performed simultaneously, some may not be required, or others may be added.

The flowchart 300 begins at block 305 where a determination is made that a headset is placed on a user's head. The determination may be made based on user input, such as a user initiating operation with the device, or it may occur automatically. For example, in some embodiments, the device may use sensor data such as image data, IMU data, or the like, to determine contextual cues which may indicate that the device has been mounted on a user's head.

The flowchart 300 continues at block 310, where a nominal IOD is calculated using a nominal eye model. According to one or more embodiments, a nominal eye model may represent characteristics of a generic eye such that predictions of a detected eye may be made. To that end, the nominal eye model may be additionally based on a calibration of the headset. For example, the nominal eye model may be based on nominal calibration data, device-specific calibration data, or some combination thereof. Sensor data, such as image data or other data used for eye tracking, can be collected and used in conjunction with the nominal eye model to predict a user IOD, referred to herein as a nominal IOD. The nominal IOD may, therefore, be a predicted measurement between the user's eyes based on a generic eye model.

At block 315, the nominal IOD is compared against a stored user IOD to determine a difference. According to one or more embodiments, the stored user IOD may be an IOD previously calculated for a user using a nominal IOD model for which the device was fitted. In some embodiments, the stored user IOD may be obtained from unencrypted storage, or storage which otherwise does not require authentication. As such, the user IOD may be stored without identifying data. Rather, the stored user IOD may indicate an IOD calculated using the nominal eye model which led to the current placement of the optical modules.

A determination is made at block 320 as to whether the user IOD difference satisfies a threshold. That is, a current user's IOD as calculated using the nominal eye model (i.e., the nominal IOD) is compared against a stored IOD value indicative of an IOD calculated using the nominal eye model stored during a prior fitting of the headset. Said another way, a determination is made as to whether the current user's IOD as calculated using a nominal eye model is within a threshold distance for a prior determined nominal IOD using the nominal eye model. The stored user IOD may be associated with a primary user of the device. Accordingly, in some embodiments, the user IOD may be used to identify the primary user during different instances of donning the device. In some embodiments, a stored user IOD may not be available, such as if a primary user is donning the device for the first time. In these instances, the difference between the nominal IDO and the user IDO will be determined to satisfy the threshold. The difference threshold may be determined, for example, based on a predefined optical tolerance at which the difference is imperceptible or otherwise allowable for presenting passthrough content for a user. As such, the optical tolerance may be predefined for the device, user defined, or the like.

If a determination is made at block 320, that the nominal IOD and the user IOD difference satisfies a threshold, then the flowchart proceeds to block 325. This may occur, for example, if a primary user is donning the headset for the first time, or if a guest is donning the headset such that the guest user's measured nominal IOD is different than the stored user IOD. At block 325, a target IOD is set as the calculated nominal IOD from block 310. The flowchart 300 then proceeds to block 330, where an adjustment process is initiated, as will be described in greater detail below.

Returning to block 320, if the difference between the calculated nominal IOD and the user IOD does not satisfy the difference threshold, then the flowchart 300 proceeds to block 360, where a determination is made as to whether a difference between a current device IOD is and a stored device IOD satisfies a difference threshold. According to one or more embodiments, the current device IOD may be a distance between two optical modules of the headset as reported by the device. The distance may be determined, for example, based on a target viewing location on each display. This may be located at a central region of each display, or some other location on the display. In some embodiments, the current device IOD may be determined based on data reported from motors configured to move the optical modules. The stored device IOD may be a previously determined IOD stored after the adjustment process was run during a setup process, or a refinement process (as described below). As such, the device IOD may indicate a primary user's IOD preference, and may differ from the user IOD, which is used against a nominal eye model to identify the user. A difference between the current device IOD and the stored device IOD may indicate that the optical modules have been moved since the device IOD was last stored. For example, one or both of the optical modules may have been unintentionally moved, intentionally adjusted by a user, or the like. The threshold may be determined, for example, based on a predefined optical tolerance. If a determination is made at block 360 that the device IOD difference satisfies a difference threshold, then the flowchart proceeds to block 365, and a target IOD is set as the stored device IOD. For example, a primary user may be identified at block 320 based on the similarity between the calculated nominal IOD and the user IOD. At block 360, a determination may be made that the current device IOD differs from that user's preferred IOD (e.g., the stored device IOD), thereby resulting in a need to adjust the optical modules to a target set as the stored device IOD.

At block 330, an adjustment process is initiated to modify the device IOD. According to some embodiments, the adjustment process may be automatically performed, user initiated, or some combination thereof. In some embodiments, an updated nominal IOD may be calculated when the adjustment process is initiated. The updated nominal IOD may be calculated to address a situation in which the device has settled on a user's head between the time the nominal IOD was targeted at block 310 and the adjustment process was initiated at block 330, particularly if the nominal IOD is used as a target, as described with respect to block 325.

At block 335, the adjustment process includes determining a target movement of the optical modules. Determining a target movement may include determining a distance and direction that each of the optical modules need to move such that the difference between the device IOD and the nominal IOD are within the allowable difference. The target may be based on the set target from block 325 or block 365, for example. The particular distance may be based on various considerations. For example, for smaller nominal IODs, such as nominal IOD measurements below a predetermined threshold, the optical tolerance may be utilized to determine a buffer such that the optical modules will be positioned at an acceptable device IOD, while reducing the risk of the optical modules moving close enough together to make contact with a user's nose. In some embodiments, the target movement may include a symmetric movement for each of the left optical module and right optical module. Alternatively, a separate target movement may be determined independently for each of the left optical module and right optical module such that the target movements of the left optical module and right optical modules are not symmetric, or if the current placement of the optical modules is not symmetric based on a prior asymmetric adjustment.

The flowchart 300 proceeds to block 340, where user prompt is presented for user input which causes the optical modules to move. According to some embodiments, the user prompt may be a visual prompt, such as text and/or directional information presented on a display of the headset. Alternatively, the user prompt may be provided in an audio format, using haptic feedback, or the like. The headset may include an input component such as a button or crown component which, when pressed or otherwise activated, triggers one or more motors in the headset to move the optical modules in accordance with the target movements. The user input may include, for example, a button press, crown turn, dial turn, or the like. The input component may trigger the movement of the optical modules mechanically, electronically, or some combination thereof.

At block 345, the target movement is initiated in response to the user input. In some embodiments, the target movement is only activated while a user is engaging the input component. As such, if a user ceases engagement of the input component, then the target movement may stop. For example, when a user ceases engagement of the input component, the one or more motors may cease the target movement of the optical modules. Further, in some embodiments, upon ceasing the target movement, the device may cause the optical modules to retreat in an opposite direction from the target movement. This reverse movement may be performed for a predefined distance, or may be proportional to the overall target movement distance, and may compensate for a user's delayed reaction in ceasing engagement with the input component, or a latency between when the user is engaged the input component and the motors ceased the target movement.

The flowchart continues to block 350, where the device IOD is optionally stored. The device IOD may be indicative of a current optical module placement, and may be stored for the primary user (e.g., when the calculated nominal IOD and user ID difference failed to satisfy a threshold at block 320). The device IOD may be stored such that it can be retrieved for adjustment of the optical modules the next time the primary user dons the headset. In some embodiments, a primary user may update the stored device IOD if the user moves the optical modules in line with the primary user's preference. The stored device IOD may be used to reference the preference.

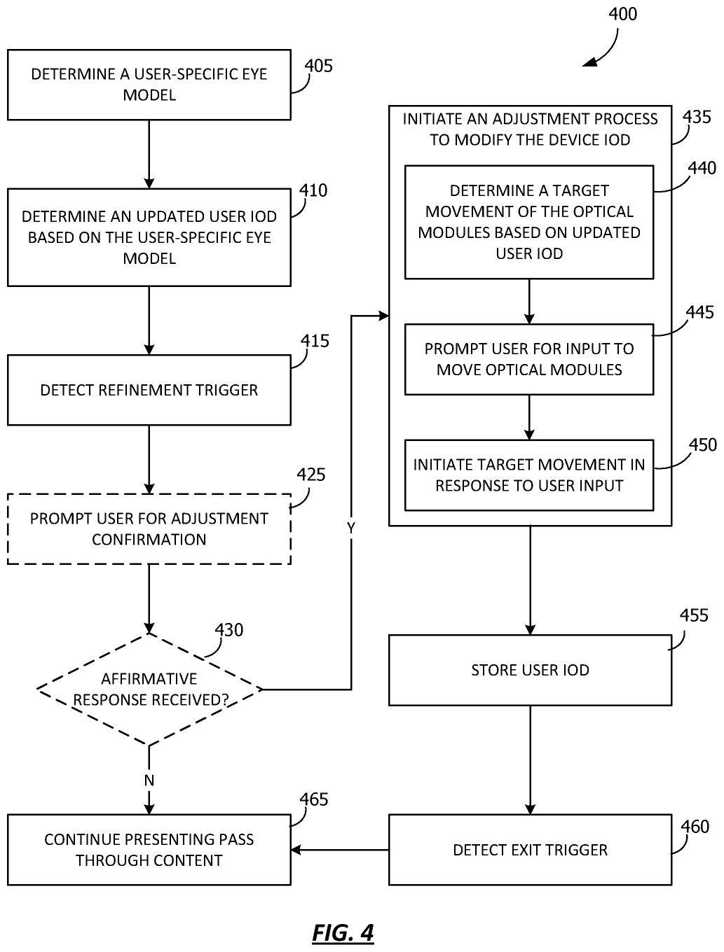

Optionally, at block 355, a user IOD is stored. In some embodiments, while the device may store some information for a primary user, such as the user IOD, the device may be used by other users, such as “guest” users. Upon determining a user IOD during an initial setup, the user IOD may be stored as being associated with a primary user, or may otherwise be stored upon confirmation the IOD to be stored as the user IOD is associated with a primary user of the device. The user IOD may not be stored in future setups as described in the flowchart 300. By not storing the user IOD during every setup process, guest users may utilize the device at an IOD specific to the guest user without affecting the stored user IOD for the primary user. Thus, the device may be initialized in a guest mode. Additionally, or alternatively, the user IOD may be updated upon user request, or upon triggering events such as a primary user refining the IOD of the device as will be described below with respect to FIG. 4.

According to one or mor embodiments, the nominal IOD may be recalculated after adjustment. In some embodiments, the nominal eye model is used again to recalculate the nominal IOD from a current placement of the optical modules. The recalculated nominal IOD is then stored as the user IOD at block 355, for example for the primary user. In some embodiments, the stored user IOD may or may not be stored with identifying information for the primary user. In some embodiments, the user IOD may be stored as an IOD value calculated using the nominal eye model without information identifying the user for which the value was calculated. These values may be used when a user places the device on their head and in new instance. The flowchart then concludes at block 370, where the device is initiated. The device may also be initiated if the user IOD difference and the device IOD difference both fail to satisfy corresponding thresholds, indicating a good match between a current IOD and the user IOD. In some embodiments, initiating the device may involve enabling passthrough functionality on the device. By enabling passthrough functionality in response to the adjustment process, the negative effect of the mismatch between the nominal IOD and the device IOD may be limited. In some embodiments, initiating the device may include enabling an XR experience.

According to one or more embodiments, if a primary user uses the device to adjust the IOD, then removes the device and again dons the IOD, the user IOD and a nominal IOD will be compared to determine if the primary user's IOD and measured nominal IOD are within a threshold. If so, then the difference threshold is not satisfied, and the flowchart proceeds to block 360. If the current device IOD is substantially similar to the stored device IOD, then the device can be initiated without further adjustment.

By contrast, if a guest dons the device a second time, a determination will be made that the nominal IOD and the user IOD are substantially different so as to satisfy the threshold. The target will be set as the measure nominal IOD, and the adjustment process begins at block 330. However, if a guest is donning the device at a second time, when the target movement is determined, it may be determined that no movement is needed because the current device IOD is still set at the guest user's nominal IOD from the last wear.

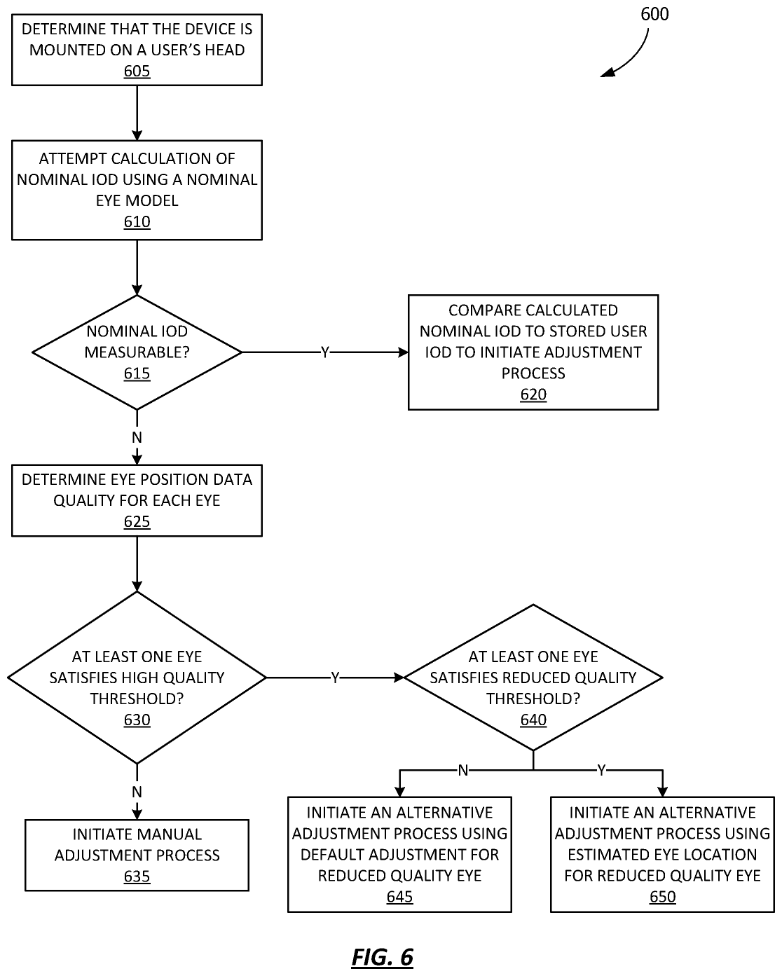

In some embodiments, the techniques described above may be modified for monocular users, or users with low visibility. For example, for users who only use a single optical module, the process may be performed for moving a single optical module to a target. The second optical module may remain still, or may be moved to a predefined position, or a position associated with a largest device IOD, for example for user comfort. In some embodiments, audio prompts may be used to assist a user in performing the adjustment process. Alternative adjustment techniques will be described in greater detail below with respect to FIG. 6.

FIG. 4 shows a flowchart for adjusting a headset fit in accordance with a user-specific eye model, in accordance with one or more embodiments. In particular, the flowchart presented in FIG. 4 depicts an example technique refining an adjusted headset fit based on user-specific data. For purposes of explanation, the following steps will be described as being performed by particular components of FIGS. 1-2. However, it should be understood that the various actions may be performed by alternate components. In addition, the various actions may be performed in a different order. Further, some actions may be performed simultaneously, some may not be required, or others may be added.

The flowchart 400 begins at block 405, where a user-specific eye model is determined. In some embodiments, the user-specific eye model may be a model that represents characteristics of the eye and is specific to the user, in contrast to the nominal eye model, which is based on a generic eye. The user-specific eye model may be generated, for example, during an enrollment process or during normal use, as the headset captures sensor data of the eye. The headset may use the eye tracking data to determine unique characteristics of the user's eye such that the device can perform gaze tracking and other functionality.

The flowchart 400 continues at block 410, where an updated user IOD is determined based on the user-specific eye model. According to some embodiments, the user IOD may be determined as or be based on a distance between the user's eyes as determined by the user-specific eye model. In some embodiments, the user-specific eye model may be used to determine a location of each of the eyes. The location may be based on a pupil location, central eye location, or the like. In some embodiments, eye tracking data may be used to determine a gaze vector from the eye. An opposite vector from the gaze vector may be projected into the eye by a predefined or user-specific distance to determine a central point within the eyeball. The headset may determine the central point in a coordinate system consistent with the device. The distance between the central points of both eyeballs may indicate the user IOD.

At block 415, a refinement trigger is detected. The refinement trigger may be a user request to adjust the headset fit, or may be based on triggering events detected by the device. As an example, generation of a user-specific eye model may be a triggering event. As an alternative example, detection of an unexpected movement of the optical modules may be a triggering event.

At block 425, optionally, a user is prompted for input to confirm adjustment of the optical modules. For example, a visual or audio display may be presented to the user inviting the user to initiate an adjustment process. Further, in some embodiments, the user prompt may be presented in the form of an option from a menu, or the like. At block 430, a determination is made as to whether an affirmative response is received. For example, the affirmative response may be confirmation that the user requests to perform the adjustment. The affirmative response may be entered in the form of a button press, voice selection, the selection of the user input component displayed on a user interface, or the like. If at block 430 an affirmative response is not received, the flowchart concludes at block 465, and the XR experience continues. In some embodiments, the XR experience may include presenting passthrough content using the current system configuration.

If at block 430 a determination is made that the affirmative response is received, then the flowchart proceeds to block 435. At block 435, an adjustment process is initiated to modify the device IOD from a current IOD. For example, as described above with respect to FIG. 3, the current IOD may be based on a nominal IOD. However, in some embodiments, the current IOD may be based on a previously determined user IOD based on a user-specific eye model. In some embodiments, an updated current IOD may be calculated when the adjustment process is initiated. The updated current IOD may be calculated to address a situation in which the device has settled on a user's head between the time the user IOD was determined at block 410 and the adjustment process was initiated at block 435.

At block 440, the adjustment process includes determining a target movement of the optical modules. Determining a target movement may include determining a distance and direction that each of the optical modules need to move such that the difference between the current IOD of the device and the updated user IOD based on the user-specific eye model are within the allowable difference or accommodation value. The particular distance may be based on various considerations. For example, for smaller IODs, such as a user IOD measurement below a predetermined threshold, an optical tolerance may be utilized to determine a buffer such that the optical modules will be positioned at an acceptable device IOD, while reducing the risk of the optical modules moving close enough together to make contact with a user's nose. However, in some embodiments, the determined buffer may be used for adjustment made based on a nominal eye model, but not a user-specific eye model due to the increased accuracy of the user IOD determined based on the user-specific eye model. In some embodiments, the target movement may include a symmetric movement for both the left optical module and right optical module. Alternatively, a separate target movement may be determined independently for the left optical module and right optical module such that the target movements of the left optical module and right optical modules are not symmetric. In some embodiments, physical constraints of the optical modules, the motors, or the device may be considered in determining the target movement.

The flowchart 400 proceeds to block 445, where a user prompt is presented for user input, which causes the optical modules to move. According to some embodiments, the user prompt may be a visual prompt, such as text and/or directional information presented on a display of the headset. Alternatively, the user prompt may be provided in an audio format, using haptic feedback, or the like. The headset may include an input component such as a button or crown component which, when pressed or otherwise engaged, triggers one or more motors in the headset to move the optical modules in accordance with the target movements. The user input may include, for example, a button press, crown turn, dial turn, or the like. The input component may trigger the movement of the optical modules mechanically, electronically, or some combination thereof.

At block 450, the target movement is initiated in response to the user input. In some embodiments, the target movement is only activated while a user is engaging the input component. As such, if a user ceases engagement of the input component, then the target movement may stop. For example, when a user ceases engagement of the input component, the one or more motors may cease the target movement of the optical modules. Further, in some embodiments, upon ceasing the target movement, the device may cause the optical modules to retreat in an opposite direction from the target movement. This reverse movement may include a predefined distance, or may be proportional to the overall target movement distance, and may compensate for a user's delayed reaction in ceasing engagement with the input component or a latency between when the user is engaged the input component and the motors ceased the target movement.

The flowchart continues to block 455, where the user IOD is stored. The user IOD may be the updated user IOD calculated at block 410. These values may be used when a user places the device on their head in a new user session with the headset. Because the personal user IOD is determined using the user-specific eye model, the personal user IOD may differ from the user IOD stored in FIG. 3. Further, in some embodiments, the personal user IOD is stored in secure storage, which is not accessible without authentication, thereby preserving user privacy. According to one or more embodiments, because the user IOD calculated at block 410 is based on a user-specific eye model on the device, the updated user IOD may be associated with a primary user of the device. However, if the updated user IOD is not related to the primary user of the device, the updated user IOD may not be stored in some embodiments.

The flowchart proceeds to block 460 where an exit trigger is detected. According to some embodiments, the exit trigger may include a gesture or other user command to exit the adjustment process. Alternatively, the exit trigger may include a timeout or other condition. The flowchart then concludes at block 465, where the XR experience continues. The XR experience may include enabling passthrough functionality on the device. By enabling passthrough functionality in response to the adjustment process, the negative effect of the mismatch between the nominal IOD and the device IOD may be limited.

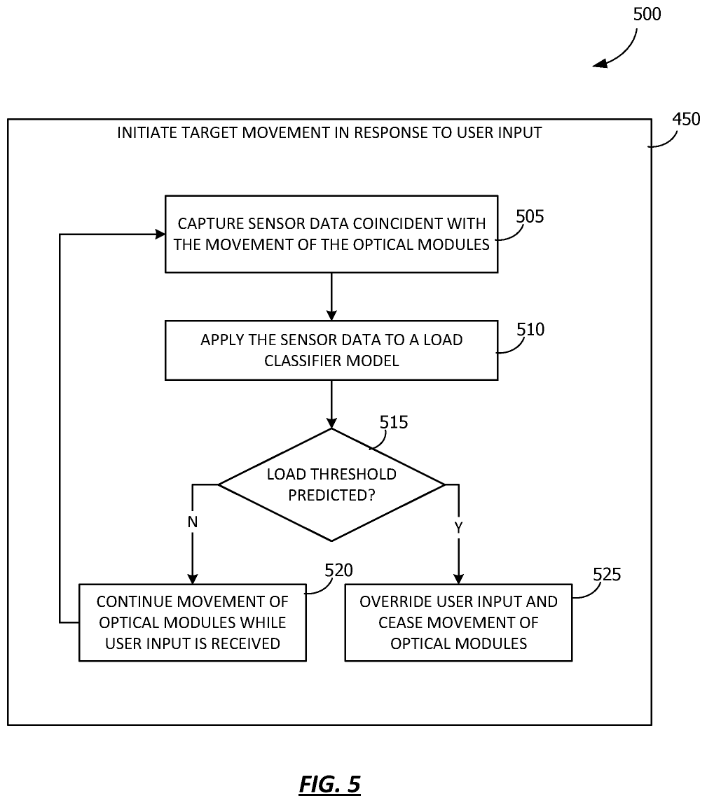

According to some embodiments, the headset may include functionality to detect or predict contact between an optical module and the bridge of a user's nose such that the headset can override a directive to move one or both optical modules to avoid or mitigate contact with the user. FIG. 5 shows a flowchart of a technique for performing a target movement of optical modules on a headset, in accordance with some embodiments. For purposes of explanation, the following steps will be described as being performed by particular components. However, it should be understood that the various actions may be performed by alternate components. In addition, the various actions may be performed in a different order. Further, some actions may be performed simultaneously, some may not be required, or others may be added.

The flowchart 500 begins with the step of initiating target movement in response to user input from block 450 of FIG. 4. The flowchart 500 begins at block 505, where sensor data is captured coincident with the movement of the optical modules. The sensor data may include, for example, temperature, current, motor control data, and the like. The sensor data may capture characteristics of the optical modules or the headset in which the optical modules are comprised. Additionally, or alternatively, the sensor data collected may be associated with a user. For example, image data may be captured of a user's nose to determine surface characteristics of the nose.

The flowchart 500 continues to block 510, where the sensor data is applied to a load classifier model. The load classifier model may a neural network or other trained model configuring to ingest sensor data to classify a load of the motors moving the optical modules, thereby providing a load classification. For example, characteristics such as current going into the system, the amount of energy applied to and/or read from a motor controller, a speed at which the motors are moving, or some combination thereof could be applied to the load classifier, where the sensor data is analyzed for signatures indicative of whether or not contact is occurring. Examples of additional sensor data which can be used include temperature sensor data, IMU sensor data, audio data from a microphone, camera data for example from one or more user-facing cameras, and the like. As such, the load classifier may classify a current state of the optical modules as in contact or not in contact with the user.

The flowchart 500 proceeds to block 515, where a determination is made as to whether contact is currently detected. Whether the contact is detected may be based on the load classifier, or other components or contextual cues from the headset. If a determination is made at block 515 that contact is not currently detected, the flowchart proceeds to block 520, and the headset continues movement of the optical modules while user input is received. The flowchart then returns to block 505, and sensor data continues to be captured coincident with the movement of the optical modules.

Returning to block 515, if a determination is made that contact is currently detected, then the flowchart concludes at block 525. At block 525, the user input to trigger the movement of the motors is ignored, and the movement of the optical modules is ceased. For example, a signal may be transmitted to the motor to cease movement of the optical modules. In some embodiments, upon ceasing the target movement, the device may cause the optical modules to retreat in an opposite direction from the target movement. This reverse movement may include a predefined distance or may be proportional to the overall target movement distance. According to some embodiments, the retreat distance may be based on a last location of the optical modules at which contact was not detected by the load classifier. Accordingly, the headset may include a buffer or other data store for tracking locations of the optical modules along with a determination as to whether the location is associated with detected contact. In some embodiments, the headset will override the user input and cease movement of the optical modules based on the detected contact to reduce or mitigate contact between the user's nose and the optical modules.

According to some embodiments, alternative techniques may be used to modify a device IOD to improve user fit, for example to improve accessibility. For example, alternative techniques can be used if data for one or both eyes is missing or unreliable. FIG. 6 shows a flowchart of selecting alternative techniques for modifying a device IOD to improve user fit, in accordance with one or more embodiments. For purposes of explanation, the following steps will be described as being performed by particular components of FIGS. 1-2. However, it should be understood that the various actions may be performed by alternate components. In addition, the various actions may be performed in a different order. Further, some actions may be performed simultaneously, some may not be required, or others may be added.

The flowchart 600 begins at block 605, where a determination is made that the device is mounted on a user's head. The determination may be made based on user input, such as a user initiating operation with the device, or it may occur automatically. For example, in some embodiments, the device may use sensor data such as image data, IMU data, or the like, to determine contextual cues which may indicate that the device has been mounted on a user's head.

The flowchart 600 continues to block 610, where a nominal IOD is calculated using a nominal eye model. According to one or more embodiments, a nominal eye model may represent characteristics of a generic eye such that predictions of a detected eye may be made. To that end, the nominal eye model may be additionally based on a calibration of the headset. For example, the nominal eye model may be based on nominal calibration data, device-specific calibration data, or some combination thereof. Sensor data, such as image data or other data used for eye tracking, can be collected and used in conjunction with the nominal eye model to predict a user IOD, referred to herein as a nominal IOD. However, in some embodiments, the sensor data collected may be insufficient to calculate a nominal IOD. This may occur, for example, if one or both of the user's eyes are situated such that insufficient sensor data of the eyes is calculated. For example, the eye may be positioned in a manner such that the eye cannot be captured by the sensor, or the eye could be missing altogether. As another example, the pose of the eye may be such that insufficient sensor data can be collected, such as if the eye is looking away when the nominal IOD calculation relies on an eye looking directly ahead.

A determination is made at block 615 as to whether the nominal IOD is measurable using the sensor data. In one or more embodiments, the determination as to whether the nominal IOD is measurable may include, for example, determining a quality metric for the sensor data and comparing the quality metric to predefined quality parameters for the nominal IOD measurement. If a determination is made at block 615 that the nominal IOD is measurable using the sensor data, then the flowchart concludes at block 620, and the calculated nominal IOD is compared to a stored user IOD to initiate the adjustment process, as described above with respect to block 330 of FIG. 3.

Returning to block 615, if a determination is made that the nominal IOD is not measurable using the sensor data, then the flowchart 600 proceeds to block 625. At block 625, a quality metric is determined for the eye position data for each eye. For example, if the eye is clearly captured by the sensor data, then the eye data may be associated with a high confidence value. On the other hand, if the eye is not clearly captured or is missing, then the eye data may be associated with a low confidence value. At block 630, a determination is made as to whether at least one of the eyes is associated with eye position data that satisfies a high quality confidence threshold. According to one or more embodiments, the high quality confidence threshold may indicate a confidence value at which the position of the eye can be determined, such as a clear view of an eye in the sensor data.

If at block 630, a determination is made that neither of the eyes is associated with eye position data that satisfies a high quality confidence threshold, then the flowchart concludes at block 635. At block 635, a manual adjustment process is initiated. In a manual adjustment process, a user may view prompts and adjust the optical modules accordingly to adjust the IOD of the device. There are various approaches that can be employed for directing a user to adjust the optical modules. In a first example, image clarity can be used. For example, the device may present an image or pattern on the display, and the user will be directed to move the optical modules until the image or pattern becomes clear. In a second example, chromatic aberrations can be used. For example, if the lenses are misaligned, the lenses will refract incoming light in manner that leads the user to see a rainbowing effect. The user may be directed to move the optical modules until the rainbowing effect subsides. In a third example, an expected field of view may be used. A pattern or object may be displayed which should be in the field of view of the user, and the user may be directed to move the optical modules until the object or pattern comes into view. Further, in some embodiments, a combination of these techniques, or alternative techniques, can be used to guide a user to adjust the optical modules.

Returning to block 630, if a determination is made that at least one of the eyes is associated with eye position data that satisfies a high quality confidence threshold, then the flowchart continues at block 640, and a determination is made as to whether at least one eye satisfies a reduced quality threshold. For example, if some data is captured of the eye, and a location of the eye can be inferred but not calculated or more directly determined, then the eye may be associated with a quality metric that satisfies a reduced quality threshold. As an example, if a pupil is detectable in the image data but is directed in an unexpected direction, then a position of the eye may be inferred or estimated from the pupil location, but will not be as precise as if the eye were gazing in the expected direction.

If at block 640, a determination is made that at least one eye does not satisfy the reduced quality threshold, then the flowchart 600 concludes at block 645, and an alternative adjustment process is initiated using default adjustments for the reduced quality eye. For example, the eye for which high quality data was identified at block 630 can be used to place the corresponding optical module on the device such that the optical module is situated in front of the eye. For the remaining eye for which insufficient data is available, a default option can be used. As an example, a nasopupilary distance between the center of the nose and the eye location for the eye with high quality data can be determined. In some embodiments, the device may infer a symmetric face and may move the other optical module to a position having the same nasopupilary distance as the known eye location. As another example, the optical module corresponding to the eye for which insufficient data is available can be moved out of the way of the user. For example, the optical module can be moved to a furthest distance available away from the user nose or other predefined position.

Returning to block 640, a determination is made that at least one eye satisfies the reduced quality threshold, then the flowchart 600 concludes at block 650, and an alternative adjustment process is initiated using an estimated eye location for the reduced quality eye. For example, in the situation where the pupil location is available but not the eye location, a vector of a predefined length can be drawn from the center of the pupil backward toward the eye to estimate the center of the eye. As another example, other characteristics of the user's eyes or face can be used to estimate the location of the eye. The optical module for the eye corresponding to the reduced quality data can then be moved to the estimated eye position.

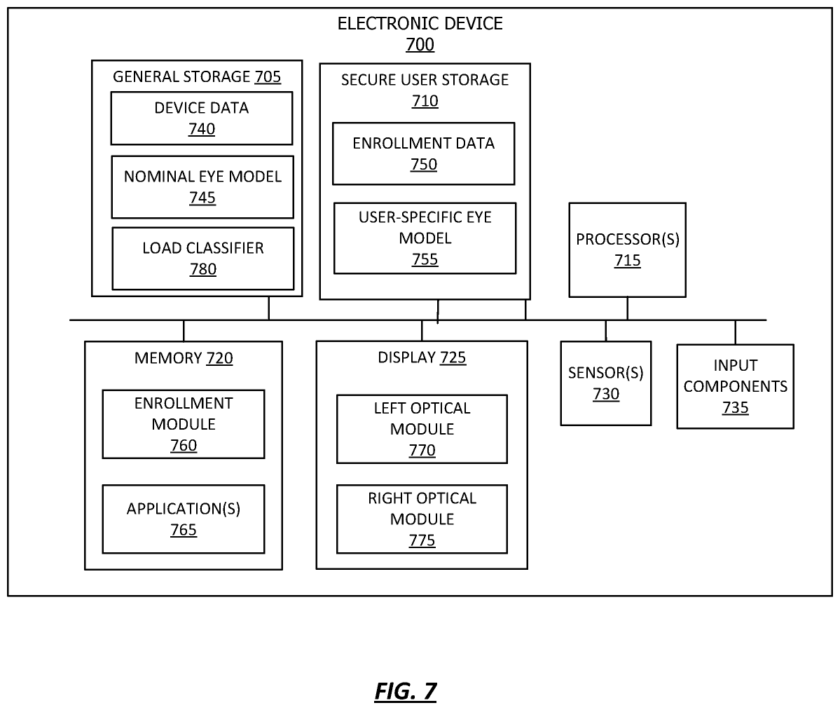

Referring to FIG. 7, a simplified block diagram of an electronic device 700 is depicted. Electronic device 700 may be part of a multifunctional device, such as a mobile phone, tablet computer, personal digital assistant, portable music/video player, wearable device, head-mounted systems, projection-based systems, base station, laptop computer, desktop computer, network device, or any other electronic systems such as those described herein. Electronic device 700 may include one or more additional devices within which the various functionality may be contained or across which the various functionality may be distributed, such as server devices, base stations, accessory devices, etc. Illustrative networks include, but are not limited to, a local network such as a universal serial bus (USB) network, an organization's local area network, and a wide area network such as the Internet. It should be understood that the various components and functionality within electronic device 700 may be differently distributed across the modules or components, or even across additional devices.

Electronic Device 700 may include one or more processor(s) 715, such as a central processing unit (CPU) or graphics processing unit (GPU). Electronic device 700 may also include a memory 720. Memory 720 may include one or more different types of memory, which may be used for performing device functions in conjunction with processors 715. For example, memory 720 may include cache, ROM, RAM, or any kind of transitory or non-transitory computer-readable storage medium capable of storing computer-readable code. Memory 720 may store various programming modules for execution by processors 715, including enrollment module 760, and other various applications 765. Memory 720 may include additional programming modules to perform functionality on the device, such as eye tracking, gaze detection, user input, and the like. Electronic device 700 may also include storage, such as general storage 705 and secure user storage 710. General storage 705 and secure user storage 710 may each include one more non-transitory computer-readable mediums, including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). General storage 705 and secure user storage 710 may be comprised in separate storage devices, or together in a single storage device. In some embodiments, general storage 705 includes data accessible on the electronic device 700 without user sign-in or with less permissions, whereas secure user storage 710 may include encrypted storage which is only accessible upon user authentication.

General storage 705 may be configured to store device data, such as a device IOD, which may be the IOD at which the device is currently set. General storage 705 may additionally include a nominal eye model 745, which is based on a generic eye and not specific to any particular user. General storage 705 may also include a load classifier model 780 which is trained to classify the load on the motors of the electronic device 700 to determine whether contact is occurring. Secure user storage 710 may be configured to store enrollment data 750. Enrollment data 750 may include data related to a particular user account for use by the electronic device. Secure user storage 710 may also store the user-specific eye model 755. Electronic device 700 may additionally include a network interface from which the electronic device 700 can communicate across a network. In some embodiments, the device data 740 maintains a nominal IOD as part of device data 740 such that when a user places the headset on their head, an IOD measured using the nominal eye model 745 can be used to determine whether adjustment is needed without having to access the user-specific eye model or user IOD which may be stored in secure user storage 710. In doing so, even if the nominal eye model inaccurately measures user IOD, the inaccurate measurement will be consistent each time the user dons the device, thereby allowing a determination to be made as to whether the adjust the optical modules without having to authenticate the user.

The optical modules may include a left optical module 770 and a right optical module 775, which together are part of a display system 725. Display 725 may be an opaque display or may be semitransparent or transparent. Display 725 may incorporate LEDs, OLEDs, a digital light projector, liquid crystal on silicon, or the like. The optical modules may be adjustable to align with multiple user IODs. In some embodiments, the optical modules are adjusted in response to user input triggering the motor to move the optical modules, such as input components 735, which may include a button, crown, or the like.

Electronic device 700 may also include one or more cameras or other sensor(s) 730, such as a depth sensor, from which depth of a scene may be determined, such as a region in front of the electronic device, or behind the electronic device, such as a user wearing a headset. In one or more embodiments, each of the one or more cameras may be a traditional RGB camera or a depth camera. Further, camera(s) may include a stereo camera or other multicamera system. In addition, electronic device 700 may include other sensors 730 which may collect sensor data for tracking user movements, such as a depth camera, infrared sensors, or orientation sensors, such as one or more gyroscopes, accelerometers, and the like. The electronic device 700 may include internal sensors 730 as well, such as temperature sensors, current sensors, and other sensors 730 related to the motor controlling movement of the optical modules.

Although electronic device 700 is depicted as comprising the numerous components described above, in one or more embodiments, the various components may be distributed across multiple devices. Accordingly, although certain calls and transmissions are described herein with respect to the particular systems as depicted, in one or more embodiments, the various calls and transmissions may be made differently directed based on the differently distributed functionality. Further, additional components may be used, and some combination of the functionality of any of the components may be combined.

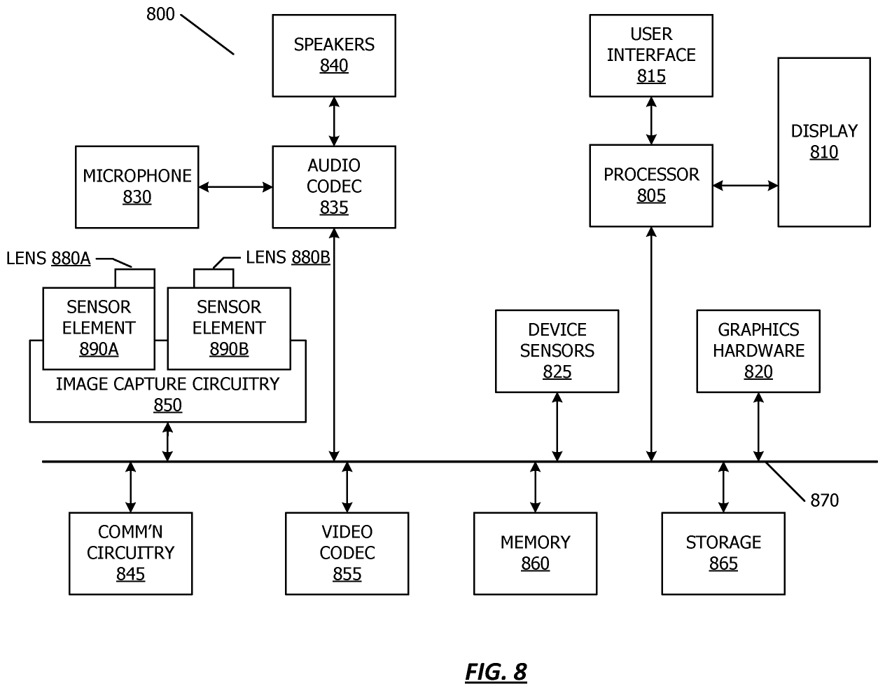

Referring now to FIG. 8, a simplified functional block diagram of illustrative multifunction electronic device 800 is shown according to one embodiment. Each of electronic devices may be a multifunctional electronic device or may have some or all of the described components of a multifunctional electronic device described herein. Multifunction electronic device 800 may include a processor 805, display 810, user interface 815, graphics hardware 820, device sensors 825 (e.g., proximity sensor/ambient light sensor, accelerometer and/or gyroscope), microphone 830, audio codec(s) 835, speaker(s) 840, communications circuitry 845, digital image capture circuitry 850 (e.g., including camera system), video codec(s) 855 (e.g., in support of digital image capture unit), memory 860, storage device 865, and communications bus 870. Multifunction electronic device 800 may be, for example, a digital camera or a personal electronic device such as a personal digital assistant (PDA), personal music player, mobile telephone, or a tablet computer.

Processor 805 may execute instructions necessary to carry out or control the operation of many functions performed by device 800 (e.g., such as the generation and/or processing of images as disclosed herein). Processor 805 may, for instance, drive display 810 and receive user input from user interface 815. User interface 815 may allow a user to interact with device 800. For example, user interface 815 can take a variety of forms, such as a button, keypad, dial, a click wheel, keyboard, display screen, touch screen, gaze, and/or gestures. Processor 805 may also, for example, be a system-on-chip such as those found in mobile devices and include a dedicated GPU. Processor 805 may be based on reduced an instruction-set computer (RISC), a complex instruction-set computer (CISC), architectures, or any other suitable architecture and may include one or more processing cores. Graphics hardware 820 may be special purpose computational hardware for processing graphics and/or assisting processor 805 to process graphics information. In one embodiment, graphics hardware 820 may include a programmable GPU.

Image capture circuitry 850 may include two (or more) lens assemblies 880A and 880B, where each lens assembly may have a separate focal length. For example, lens assembly 880A may have a short focal length relative to the focal length of lens assembly 880B. Each lens assembly may have a separate associated sensor element 890A and 890B. Alternatively, two or more lens assemblies may share a common sensor element. Image capture circuitry 850 may capture still and/or video images. Output from image capture circuitry 850 may be processed by video codec(s) 855, processor 805, graphics hardware 820, and/or a dedicated image processing unit or pipeline incorporated within circuitry 850. Images so captured may be stored in memory 860 and/or storage 865.

Sensor and camera circuitry 850 may capture still and video images that may be processed in accordance with this disclosure, at least in part, by video codec(s) 855, processor 805, graphics hardware 820, and/or a dedicated image processing unit incorporated within circuitry 850. Images so captured may be stored in memory 860 and/or storage 865. Memory 860 may include one or more different types of media used by processor 805 and graphics hardware 820 to perform device functions. For example, memory 860 may include memory cache, read-only memory (ROM), and/or random-access memory (RAM). Storage 865 may store media (e.g., audio, image, and video files), computer program instructions or software, preference information, device profile information, and any other suitable data. Storage 865 may include one more non-transitory computer-readable storage mediums including, for example, magnetic disks (fixed, floppy, and removable) and tape, optical media such as CD-ROMs and DVDs, and semiconductor memory devices such as EPROM and EEPROM. Memory 860 and storage 865 may be used to tangibly retain computer program instructions, or code organized into one or more modules and written in any desired computer programming language. When executed by, for example, processor 805 such computer program code may implement one or more of the methods described herein.

Various processes defined herein consider the option of obtaining and utilizing a user's identifying information. For example, such personal information may be utilized in order to track motion by the user. However, to the extent such personal information is collected, such information should be obtained with the user's informed consent, and the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well established and in compliance with or above governmental/industry standards. Moreover, these parties will not distribute, sell, or otherwise share such information outside of any reasonable and legitimate purposes.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at city level rather than at an address level), controlling how data is stored (e.g., aggregating data across users), and/or other methods.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 2-3 and 5-6, or the arrangement of elements shown in FIGS. 1, 4, and 7-8, should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising, in response to a headset device being placed on a head:
calculating a nominal interocular distance (“IOD”) using a nominal eye model;
identifying a current device IOD based on a distance between a set of optical modules comprising a first optical module and a second optical module of a headset; and
based on the nominal IOD and the current device IOD, initiating an adjustment process to modify the distance between the first optical module and the second optical module.

2. The method of claim 1, further comprising:
in accordance with a completed adjustment process, enabling passthrough functionality on the headset device.

3. The method of claim 1, wherein the adjustment process comprises:
determining a difference between one or both optical centers of eyes in accordance with the nominal eye model, and one or both optical modules of the headset device;
determining a target movement of at least one of the optical modules based on the determined difference; and
triggering, in response to user input, one or more motors to cause the distance between the set of optical modules to be adjusted in accordance with the target movement.

4. The method of claim 3, further comprising:
in accordance with a determination that the user input has ceased, cease adjustment of the one or both optical modules.

5. The method of claim 3, wherein determining the target movement comprises determining a direction and distance to move at least one of the first optical module and second optical module, wherein the distance is based on the calculated nominal IOD, an accommodation value, and one or more physical constraints of the headset device.

6. The method of claim 3, further comprising:
in response to triggering the one or more motors to cause the distance between the set of optical modules to be adjusted:
capturing sensor data while the one or more motors are causing the distance to be adjusted,
applying the sensor data to a load classifier model to predict a load classification, and modifying a performance of the one or more motors based on the load classification.

7. The method of claim 1, wherein the set of optical modules are adjusted independently of each other.

8. A non-transitory computer readable medium comprising computer readable code executable by one or more processors to, in response to a headset device being placed on a head:
calculate a nominal interocular distance (“IOD”) using a nominal eye model;
compare a device IOD to the calculated nominal IOD, wherein the device IOD is based on a distance between a set of optical modules comprising a first optical module and a second optical module of the headset; and
in accordance with a determination that a difference between the device IOD and the calculated nominal IOD satisfies a threshold, initiate an adjustment process to modify the distance between the first optical module and the second optical module.

9. The non-transitory computer readable medium of claim 8, further comprising computer readable code to:
determine a user-specific eye model; and
in accordance with a determination that a difference between an IOD based on the nominal eye model and an IOD based on the user-specific eye model satisfies a threshold, trigger a refinement process.

10. The non-transitory computer readable medium of claim 9, wherein the computer readable code to trigger the refinement process comprises computer readable code to:
present a user prompt related to the refinement process; and
in accordance with receiving a response to the user prompt, perform the refinement process.

11. The non-transitory computer readable medium of claim 9, wherein the refinement process comprises:
determining a difference between one or both optical centers of eyes of a user in accordance with the user-specific eye model, and one or both optical modules of the headset device; and
determining a target movement of at least one of the optical modules based on the determined difference.

12. The non-transitory computer readable medium of claim 9, further comprising computer readable code to:
detect that the headset device is placed on the head in a second instance;
calculate an updated nominal IOD using the nominal eye model; and
compare the device IOD to the calculated nominal IOD to enable passthrough functionality on the headset.

13. The non-transitory computer readable medium of claim 12, further comprising computer readable code to:
compare the updated nominal IOD to a stored user IOD associated with a primary user profile; and
in response to a determination that the updated nominal IOD fails to satisfy a similarity threshold to the stored user IOD, initiate a guest mode.

14. The non-transitory computer readable medium of claim 9, wherein the adjustment process is selected based on a data quality metric of eye tracking data used to calculate the nominal IOD.

15. A system comprising:
one or more processors; and
one or more computer readable media comprising computer readable code executable by the one or more processors to, in response to a headset device being placed on a head:
calculate a nominal interocular distance (“IOD”) using a nominal eye model;
compare a device IOD to the calculated nominal IOD, wherein the device IOD is based on a distance between a set of optical modules comprising a first optical module and a second optical module of the headset; and
in accordance with a determination that a difference between the device IOD and the calculated nominal IOD satisfies a threshold, initiate an adjustment process to modify the distance between the first optical module and the second optical module.

16. The system of claim 15, further comprising computer readable code to:
in accordance with a completed adjustment process, enable passthrough functionality on the headset device.

17. The system of claim 15, wherein the adjustment process comprises:
determining a difference between one or both optical centers of eyes in accordance with the nominal eye model, and one or both optical modules of the headset device;
determining a target movement of at least one of the optical modules based on the determined difference; and
triggering, in response to user input, one or more motors to cause the distance between the set of optical modules to be adjusted in accordance with the target movement.

18. The system of claim 17, further comprising computer readable code to:
in accordance with a determination that the user input has ceased, cease adjustment of the one or both optical modules.

19. The system of claim 17, wherein the computer readable code to determine the target movement comprises computer readable code to:
determine a direction and distance to move at least one of the first optical module and second optical module, wherein the distance is based on the calculated nominal IOD, an accommodation value, and one or more physical constraints of the headset device.

20. The system of claim 15, further comprising computer readable code to:
determine a user-specific eye model; and
in accordance with a determination that a difference between an IOD based on the nominal eye model and an IOD based on the user-specific eye model satisfies a threshold, trigger a refinement process.
